(19) United States
(12) Patent Application Publication
(10) Pub. No.: US 2017/0000049 A1
(43) Pub. Date: Jan. 5, 2017

(54) Garden plant watering device

(71) Applicant: Terry Cox, Warner Springs, CA (US)

(72) Inventor: Terry Cox, Warner Springs, CA (US)

(21) Appl. No.: 14/801,692

(22) Filed: Jul. 16, 2015

Related U.S. Application Data
(60) Provisional application No. 62/025,978, filed on Jul. 17, 2014.

(51) Int. Cl. A01G 27/00

(52) U.S. Cl. CPC A01G 27/003; A01G 27/008; A01G 27/005

(57) ABSTRACT

This invention is directed toward a garden pot device that automatically waters garden plants and collects the drainage water. The device has a bottom portion with a source of electrical power and a pump and additionally provides support for a network of tubes leading to pots in which plants are grown. The network of tubes both provides water to the pots and collects water that drains out of the pots for use in the next watering.

### CROSS REFERENCE TO RELATED APPLICATIONS

This application claims priority back to U.S. Provisional Patent Application No. 62/025,978, filed Jul. 17, 2014, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

Field of the Invention

This invention relates to the general field of potted plants and watering devices, and more specifically toward a gardening device that automatically pumps water into one or more potted plants on a timed cycle, and then recovers the water that drains from the pots for use in subsequent waterings.

History of the Invention's Industry

While growing plants is optional and a hobby for most people, keeping plants alive and healthy can be a real challenge. Plants can grow in a variety of climates and environments, but with very few exceptions, plants need sunlight and water to grow. Placing a plant near a window or on a patio/deck will usually meet the sunlight requirement.

Water, on the other hand, is a different story. Too much or too little and you become the proud owner of a dead plant. It's been published and discussed in plant journals, that most house plants die from too much water (frequent over-watering) while in a close second place, plants die from lack of water (most likely the result of being neglected on a daily basis or forgotten during a trip). In our daily lives, maintaining a watering schedule for plants can be very difficult to follow. A few days away from home and your plants are dead. For this reason, the average house plant's life is measured in weeks, not years like outdoor plants.

The next consideration of indoor plant growing is the placement of the plant. Plants, like pets, can be messy. Besides dropping leaves, the pots can leak water, creating wet rings on tables and floors or even causing dry rot and structural failures. While plant stands may be the best solution for the placement of the potted plant, they most often do not address the plant's water needs.

There is currently no device that can allow house plants to thrive—much less live—and do so cleanly and with little effort on the part of the home owner or renter.

There exist on the market today plant stands the raise the plant above the floor, and drip basins that catch at least some of the overflow when a plant is overwatered. There are also a variety of timers that can be programmed to water a plant (or an area of plants) for a certain time period every day, or several days. However, none of these products do so cleanly: the timer that sends too much water into a pot will result in water overflowing the basin; the large drip basin may catch more water but is unsightly; the pot stand may put the plant an attractive 3′ above the floor, but that only exacerbates the problem with water spilling out of the basin, as now the water doesn't just drip over the edge but rather falls 3′ before splattering all over the room.

Thus there has existed a long-felt need for a self-contained watering unit that can water plants on regular basis, is attractive to the eye, and prevents any excess water from spilling on the floor.

The current invention provides just such a solution by having a plant stand that supports one or more plant pots, where each pot receives regular watering and where any excess water is funneled through a network of pipes back to a reservoir in the bottom of the stand where it is stored for subsequent waterings.

### OBJECTS OF THE INVENTION

It is therefore an object of the present invention to provide a means of keeping potted plants alive and healthy in an indoors environment.

Another object of the invention is to provide a means to keep a house clean when using houseplants for decoration and comfort.

Yet another object of the invention is to provide a means by which houseplants can be watered regularly, with any overflow or excess water being collected such that it does not fall on the floor.

Another object of the invention is to allow for excess water to be trapped in a manner that does not damage table tops or floors and rugs, and allows the excess water to be stored for subsequent waterings.

It is another object of the invention to extrapolate the same technologies used for the indoor potted plant version to greenhouse and outdoor environments where many potted plants are kept alive through regular watering and retrieval of the runoff.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a partial cut-away view according to a preferred form of the invention.

FIG. 2 is a schematic view illustrating the movement of water within the invention.

FIG. 3 is a cross-sectional view of the upper portion of the invention showing how the water is directed toward the plant.

### REFERENCE NUMBERS USED

1. Base unit. Contains batteries and timer as well as an electrical connection to the pump.
2. Timer. Controls water flow to plants.
3. Batteries. Provides power for timer and pump.
4. Water reservoir. Contain water supply as well as recovery basin for drainage from plants.
5. Pump. Provides water pressure to water the plants.
6. Drainage. Return water from plant drainage to reservoir.
7. Water manifold pressure Chamber. Receives water from pump and routs water to water supply tubes that go to plants.
8. Network Structure. Supports plant containers as well as concealing water supply tubes and returning water from plant drainage.
9. Water Supply tube. Routs water to plant container.
10. Irrigation harness. Delivers water to the plant.
11. Plant container. Contains potted plant.
12. Potted Plant. Potted sits inside plant container
13. Water Input. Opening for adding water
14. Electrical contact between the power supply in the base and manifold/
15. Lid of Water Reservoir.
20. Water Outlets
21. Supports
22. Connection flange

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

To summarize the invention, a pump in a reservoir of water pumps water to a series of flower pots. Each flower pot is on a pedestal, made from different arms of a support structure called a network. The amount of water and time interval between waterings is controlled by an adjustable timer. The water tubes that take the water to the flower pots branch out in the network, and then branch out again in each flower pot, such that the plants are evenly watered. Any excess water drains out a drain hole in the flower pot and is collected in the network, and funneled back into the reservoir, where it can be used in subsequent waterings. This way, a homeowner can leave for extended periods of time and rely upon the invention to keep the plants watered, but not too wet.

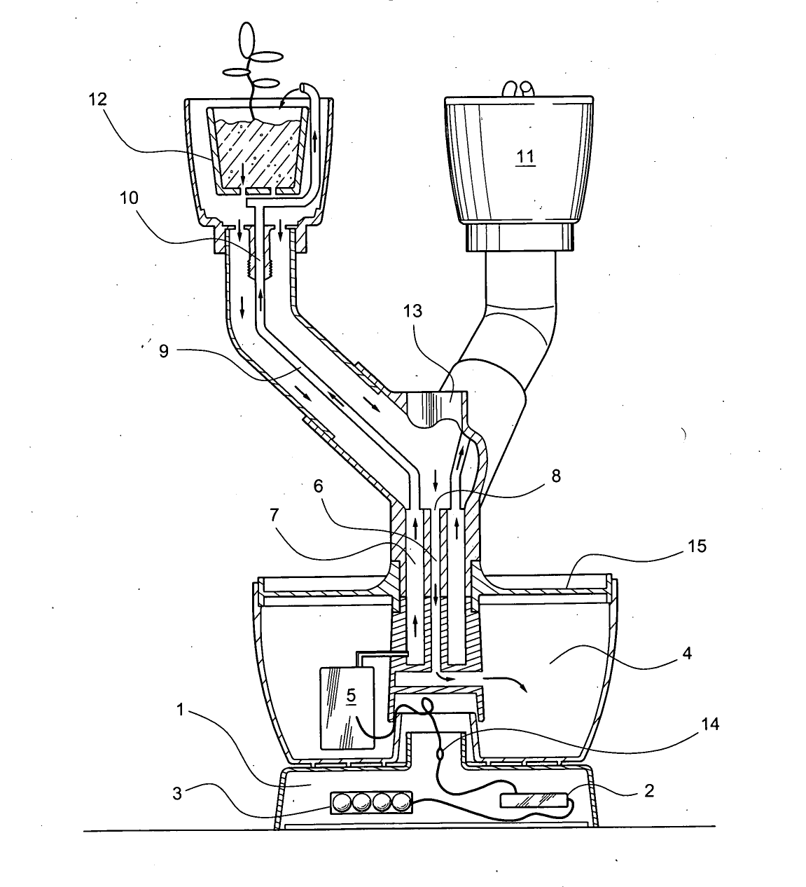

FIG. 1 is a partial cut-away view according to a preferred form of the invention. The base unit, generally referenced as 1, provides a stable platform upon which the units rests as well as the electrical power for the pump. The base unit has a lower face that is wider than an upper face to enhance stability. On the lower face of the round base unit, there are three attached feet that support the unit on the surface it is resting on. The inside of the base contains a compartment for the battery pack 3 and timer 2. The top center raised area contains the electrical contacts 14 that connect to the manifold that is attached to the water reservoir unit that houses the pump and water supply.

The reservoir, generally referenced as 4, is a bowl from which water is pumped to water the plants, and into which excess water—runoff from the plants—is collected for subsequent waterings. The water reservoir is a container that may be round, square or any similar shape that would contain both water and the pump 5. There is a raised opening in the bottom of the water reservoir that provides the connection of the manifold to the water reservoir.

Attached to the reservoir is the water manifold. The water manifold provides a number of services that include; a center support and connection fitting to the upper network, pass through access for the power cord from the pump to the power source in the base, drainage piping from the returning water from the plant containers, and is the device that receives water from the pump 5 and directs the water to the separate water supply tubes 9 to the plants.

The pump 5 pumps water to the flower pots. The pump 5 is regulated by a timer 2, with the time interval and the length of time the pump is turned on set by the user. The pump is connected to the power supply through the manifold to the base unit 1 with the batteries 3 and timer 2.

The lid 15 covers the water reservoir and serves as both a support to the network and a cover to conceal the pump from view and prevent the growth of light requiring algae in the standing water. The lid also serves as a base support for the upper network 8 when the network is removed to access the water reservoir for cleaning and adding water. The cover is attached to the network and sits on the water reservoir. The network structure connects to the manifold through the lid and the lid is part of the network structure. The manifold is connected to the water reservoir. The water reservoir sits on the base unit. If you remove the lid, the network will stay with the lid and the lid will serve as the base for the network structure.

The network structure, generally referenced by 8, is basically a multi-purpose plant stand that allows for multiple plants to be displayed, watered regularly, and have any runoff collected and used again. The network has a network base, and has a lip. The lip connects to the top of the central tube. Water supply tubes 9, are connected to the pump 5. Each water supply tube 9, has a connector end, that mates with a flower pot connector, so that water from the pump will reach the flower pots. The base branches out into two or more branches which angle out from the base, and then straighten up, terminating in a branch top upon which the flower pots rest. The network structure also has a center branch, or water pour location 13, which provides access to the water in the reservoir for refilling and the measuring water in the reservoir. The network structure passes through the lid and connects directly to the water manifold through a threaded connection.

The plant containers connects directly to the water tube such that it is easy to move a plant that is contained in a separate pot, from one location to another, or substitute another plant that are not planted directly in the plant container. The shape and size of the plant container will match the shape of the water reservoir. There is also a drainage hole in the bottom of the flower pot, through with excess water can drain through the network branches and be collected in the water reservoir 4. The bottom of the plant container also has a large enough drainage hole such that a flower pot water tube can be run up through the drainage hole and not block it. The flower pot water tube has a flower pot connector, which mates with the connector end. This allows for the easy removal of a flower pot and replacement with another flower pot. The flower pot water tube, branches into two or more tube branches, with each branch terminating in an emitter end, through which the water flows. The branching allows for multiple emitters, which allows, in turn, for a more even watering.

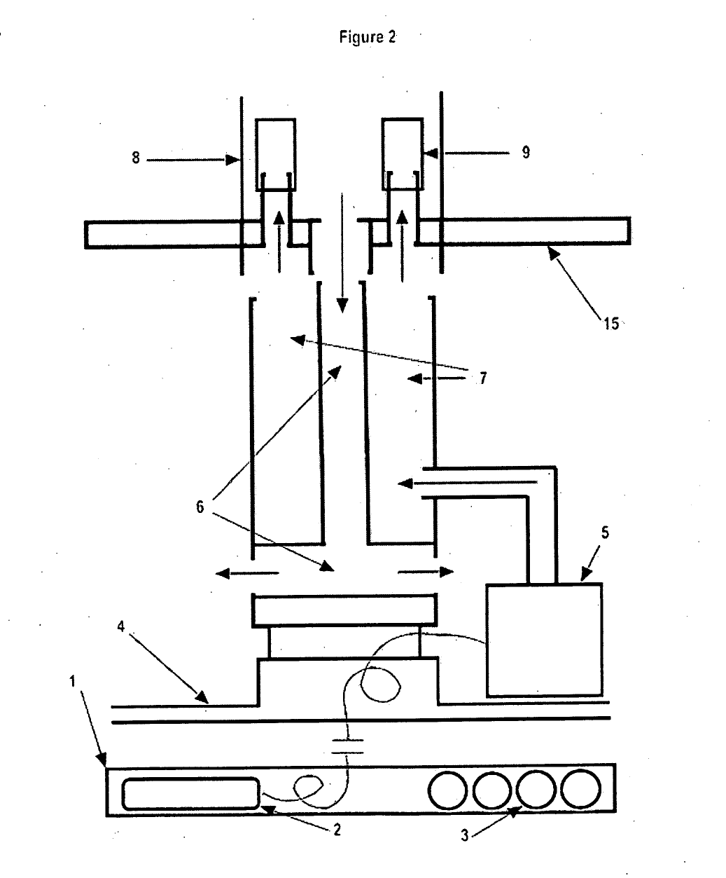

FIG. 2 is a schematic view illustrating the movement of water within the invention. The pump 5 takes water from the water reservoir 4 and pumps it first into a water manifold/pressure chamber 7, when then feeds to water into the water supply tubes 9. After the water has been dispensed to the plant, the excess water drains back into the water reservoir 4 for the next watering.

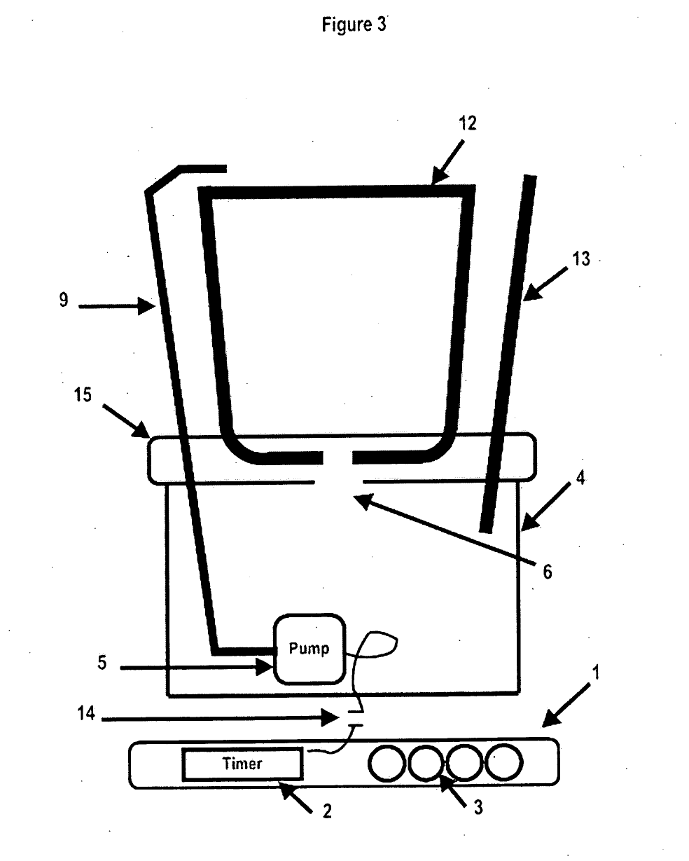

FIG. 3 is a cross-sectional view of the upper portion of the invention showing how the water is directed toward the plant. The upper portion of the network structure 8 has a Connection Flange 22 that supports the plant container 11. The water supply tube 9 is split into at least two irrigation harnesses 10 which terminate in at least two water outlets 20 which supply water to different parts of the plant. Supports 21 support the irrigation harness 10 along the sides of the plant container 11.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device for ensuring the regular watering and proper drainage of potted plants comprising:
a base unit, where the base unit is a cylindrical tower which has a height and a diameter, where the diameter is greater than the height, additionally comprising a plurality of batteries, where the plurality of batteries provide electricity to a pump, and where the base unit stabilizes the device, and a timer, where the timer regulates a flow of water to one or more plants, and a base unit electrical contact,
a reservoir unit, where the reservoir unit contains a water reservoir and a pump, where the water reservoir collects a quantity of drip water from the one or more plants, and where the pump collects a quantity of reservoir water from the water reservoir and pumps it to the one or more plants, and additionally comprising a network support, and a reservoir unit electrical contact, where the base unit electrical contact can mate with the reservoir unit electrical contact to supply power to the pump,
a network unit, where the network unit contains a bottom that can removably lock onto the reservoir unit, a pressure chamber which receives the quantity of reservoir water from the pump, at least one network branch that additionally contains one connection flange, where the connection flange has an upper diameter, and where the upper diameter is greater than a lower diameter of a plant container, such that the plant container nestles in the connection flange, and where the network branch supports at least one flower pot, at least one water supply tube through which water from the pressure chamber is transported to the at least one flower pot, at least one irrigation harness which is connected to the at least one water supply tube, where the at least one irrigation harness additionally comprises at least one water outlet, and where the at least one irrigation harness delivers a quantity of harness water to the at least one flower pot, and where the at least one water supply tube has a water supply tube diameter, and where the at least one network branch has a network branch diameter, and where the water supply tube diameter is less than the network branch diameter, such that excess water from the at least one flower pot can move through the network branch back to the reservoir, and additionally comprising a water input, where the water input comprises an opening with a detachable lid, which provides an opening through which a quantity of water can be added to replenish a water level in the reservoir unit,
at least one plant container, where the at least one plant container additionally comprises a support, where the support is connected to the irrigation harness,
and least one flower pot, where the at least one flower pot contains an open top, sides, and a drainage hole in the bottom of the flower pot, such that a quantity of excess water can drain from the flower pot into the network branch and eventually back to the reservoir.

2. A device for ensuring the regular watering and proper drainage of potted plants comprising:
the base unit, additionally comprising the plurality of batteries, and the timer, and where the base unit stabilizes the device,
the reservoir unit, where the reservoir unit contains the a water reservoir and the pump, and where the pump collects the quantity of reservoir water from the water reservoir and pumps it to the one or more plants,
the network unit, where the network unit contains at least one network branch that additionally contains one connection flange, where the connection flange has an upper diameter, and where the upper diameter is greater than the lower diameter of the plant container, such that the plant container nestles in the connection flange, and where the network branch supports at least one flower pot, at least one water supply tube through which water from the pressure chamber is transported to the at least one flower pot,
at least one plant container,
and least one flower pot, where the at least one flower pot contains an open top, sides, and the drainage hole in the bottom of the flower pot, such that the quantity of excess water can drain from the flower pot into the network branch and eventually back to the reservoir.

3. The device of claim 2, where the base unit is the cylindrical tower which has the height and the diameter, where the diameter is greater than the height, where the plurality of batteries provide electricity to the pump and the base stabilizes the device, where the timer regulates the flow of water to the one or more plants.

4. The device of claim 3, where the base unit additionally comprises the base unit electrical contact, and where the reservoir unit additionally comprises the electrical contact, where the base unit electrical contact can mate with the reservoir unit electrical contact to supply power to the pump.

5. The device of claim 4, where the water reservoir collects the quantity of drip water from the one or more plants and additionally comprising the network support.

6. The device of claim 5, where the network unit additionally comprises the bottom that can removably lock onto the reservoir unit, and the pressure chamber which receives the quantity of reservoir water from the pump and at least one water supply tube, where the at least one water supply tube takes the quantity of pump water from the pump and transmits it to the one or more plants.

7. The device of claim 6, where the network unit additionally comprises at least one irrigation harness which is connected to the at least one water supply tube, where the at least one irrigation harness additionally comprises at least one water outlet, and where the at least one irrigation harness delivers the quantity of harness water to the at least one flower pot, and where the at least one water supply tube has the water supply tube diameter, and where the at least one network branch has the network branch diameter, and where the water supply tube diameter is less than the network branch diameter, such that excess water from the at least one flower pot can move through the network branch back to the reservoir.

8. The device of claim 7, additionally comprising the water input, where the water input comprises an opening with the detachable lid, which provides the opening through which the quantity of water can be added to replenish the water level in the reservoir unit.

9. The device of claim 8, where the at least one plant container additionally comprises the support, where the support is connected to the irrigation harness, and where the number of plant containers is two.

10. The device of claim 2, where the base unit is the cylindrical tower which has the height and the diameter, where the diameter is greater than the height, where the plurality of batteries provide electricity to the pump and where the base unit stabilizes the device, where the water reservoir collects the quantity of drip water from the one or more plants.

11. The device of claim 10, where the base unit additionally comprises the bottom that can removably lock onto the reservoir unit, and the pressure chamber which receives the quantity of reservoir water from the pump.

12. The device of claim 11, where the timer regulates the flow of water to one or more plants

13. The device of claim 12, where the base unit additionally comprise the base unit electrical contact, and where the reservoir unit additionally comprises a network support, and the reservoir unit electrical contact, where the base unit electrical contact can mate with the reservoir unit electrical contact to supply power to the pump.

14. The device of claim 13, where the network unit additionally comprises at least two irrigation harnesses which are connected to at least two water supply tubes, where the at least two irrigation harnesses additionally comprises at least four water outlets, and where the at least two irrigation harnesses delivers the quantity of harness water to at least two flower pots.

15. The device of claim 14, where the at least two water supply tubes each has the water supply tube diameter, and where the at least one network branch has the network branch diameter, and where the water supply tube diameter is less than the network branch diameter, such that excess water from the at least two flower pots can move through the network branch back to the reservoir, and additionally comprising the water input, where the water input comprises the opening with the detachable lid, which provides the opening through which the quantity of water can be added to replenish the water level in the reservoir unit.

16. The device of claim 12, where each plant container additionally comprises the support, where the support is connected to the irrigation harness.

17. The device of claim 2, where the network unit additionally comprises the bottom that can removably lock onto the reservoir unit, and where the pressure chamber which receives the quantity of reservoir water from the pump.

18. The device of claim 17, where the at least one irrigation harness which is connected to the at least one water supply tube, where the at least one irrigation harness additionally comprises at least one water outlet, and where the at least one irrigation harness delivers the quantity of harness water to the at least one flower pot, and where the at least one water supply tube has the water supply tube diameter, and where the at least one network branch has a network branch diameter, and where the water supply tube diameter is less than the network branch diameter, such that excess water from the at least one flower pot can move through the network back to the reservoir, and additionally comprising the water input, where the water input comprises the opening with the detachable lid, which provides an opening through which the quantity of water can be added to replenish the water level in the reservoir unit.

19. The device of claim 18, where, where the base unit is the cylindrical tower which has the height and the diameter, where the diameter is greater than the height, where the plurality of batteries provide electricity to the pump and where the base unit stabilizes the device, where the timer regulates a flow of water to one or more plants, and the base unit electrical contact, where the water reservoir collects the quantity of drip water from the one or more plants, and additionally comprising the network support, and the reservoir unit electrical contact, where the base unit electrical contact can mate with the reservoir unit electrical contact to supply power to the pump.

20. The device of claim 18, where, where the at least one plant container additionally comprises the support, where the support is connected to the irrigation harness.
